(19) United States
(12) Patent Application Publication
(10) Pub. No.: US 2026/0278909 A1
(43) Pub. Date: Sep. 17, 2026

(54) DESCRIPTOR BASED RENDERING AND COMPUTE COMMAND REFERENCE COUNTERS

(71) Applicant: QUALCOMM Incorporated, San Diego, CA (US)

(72) Inventors: Liang LI, San Diego, CA (US); Andrew Evan GRUBER, Arlington, MA (US); Thomas Edwin FRISINGER, Shrewsbury, MA (US); Lakshmi SRINIVASAN, Littleton, MA (US); Jonnala Gadda NAGENDRA KUMAR, San Diego, CA (US); Richard HAMMERSTONE, Tyngsboro, MA (US); Md Wahidul ISLAM, Folsom, CA (US); Jiexia YU, San Diego, CA (US); Zilin YING, San Diego, CA (US); Quanquan XU, San Diego, CA (US); Heng QI, San Diego, CA (US); Srihari Babu ALLA, San Diego, CA (US); Patrick Richard BOYLE, San Diego, CA (US)

(21) Appl. No.: 19/081,838

(22) Filed: Mar. 17, 2025

(51) Int. Cl. G06T 15/00

(52) U.S. Cl. CPC G06T 15/005

(57) ABSTRACT

This disclosure provides systems, devices, apparatus, and methods, including computer programs encoded on storage media, for descriptor based rendering and compute command reference counters. A graphics processor may receive an access indication indicative of an access, to a profile descriptor data structure, for a descriptor associated with a set of rendering and compute commands for a shader resource. The graphics processor may update, based on the access indication, a descriptor count value of a descriptor reference counter that corresponds to the descriptor. The graphics processor may output an indication of the descriptor count value.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for graphics processing may utilize hardware memory transaction counters or software resource binding analysis to track resource utilization for resource priority determinations associated with memory paths, but may not address the inefficient memory path management due to insufficient resource utilization information—current hardware counters are too granular with respect to tracked information, and binding analyses do not adapt well to bindless descriptors. There is a need for improved techniques for resource utilization tracking in graphics hardware pipelines to provide software with actual/accurate hardware access information.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: receive an access indication indicative of an access, to a profile descriptor data structure, for a descriptor associated with a set of rendering and compute commands for a shader resource; update, based on the access indication, a descriptor count value of a descriptor reference counter that corresponds to the descriptor; and output, for a graphics driver, an indication of the descriptor count value.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 illustrates an example display framework including a display processor and a display in accordance with one or more techniques of this disclosure.

FIG. 5 illustrates an example architecture for descriptor based rendering and compute command reference counters in accordance with one or more techniques of this disclosure.

FIG. 6 illustrates examples of functions, shaders, and resources for descriptor based rendering and compute command reference counters in accordance with one or more techniques of this disclosure.

FIG. 7 is a call flow diagram illustrating example communications between a CPU and a graphics processor in accordance with one or more techniques of this disclosure.

FIG. 8 is a flowchart of an example method of graphics processing in accordance with one or more techniques of this disclosure.

FIG. 9 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, the term “shader resource” may refer to data, utilized by a shader to perform its functions, such as a buffer, a buffer view, an image view, a sampler, and/or the like (in such a context: the term “buffers” may refer to/represent linear arrays of data which are used for various purposes by binding them to a graphics or compute pipeline via descriptor sets or certain commands, or by directly specifying them as parameters to certain commands; the term “buffer view” may refer to/represent a contiguous range of a buffer and a specific format to be used to interpret the data. Buffer views are used to enable shaders to access buffer contents; the term “images” may refer to/represent multidimensional arrays of data that are used for various purposes (e.g. attachments, textures) by binding them to a graphics or compute pipeline via descriptor sets, or by directly specifying them as parameters to certain commands; the term “image view” may refer to/represent contiguous ranges of the image sub-resources and contain additional metadata used for that purpose (whereas, image objects are not directly accessed by pipeline shaders for reading or writing image data)). As used herein, the terms “descriptor” and “profile descriptor” may refer to an opaque data structure representing shader resources by containing information that describes sizes, dimensions, addresses, and/or the like, of the shader resources. As used herein, the term “rendering command” may refer to any type of rendering function, such as a graphic rendering draw call, a draw call generally, or the like. As used herein, the term “compute command” may refer to any type of compute function, such as a compute shader dispatch or the like, at a graphics processor, and the term “compute function” may refer to general purpose processing and/or compute shader processing. As used herein, the term “surface level” may refer to data, information, etc., associated with per-surface image data that is aggregated for a given surface. As used herein, the term “descriptor reference counter” may refer to a counter that is incremented for each access to a shader resource associated with a specific descriptor. As used herein, the term “command reference counter” may refer to a counter that is incremented for each render and compute command executed in correspondence to a shader resource associated with a specific descriptor. As used herein, the term “descriptor lookup key” may refer to an address or other identifier key that links a descriptor to a shader resource. As used herein, the term “programming update” may refer to programming of a hardware table(s) in which may include writing to hardware registers, by a graphics driver for a graphics processor, associated with the hardware table(s).

Graphics pipelines access texture resources, image resources, buffer resources, etc., through memory paths, and software management of resources according to respective hardware usage may improve memory path efficiency. Some example methods of collecting usage information are either by hardware memory transaction counters or software resource binding analysis. Memory transaction counters may be difficult to use by software, e.g., drivers) as the memory transaction granularity may be too small for utilization, tracking memory information of individual resources in modern workloads with bindless descriptors over-burdens software capabilities. Memory transaction counters may also be too sensitive to hardware internal cache/buffer configurations when there are concurrently running workloads. That is, a problem of resource analysis via software is that software does not have actual/accurate hardware access information.

Aspects herein provide for an addition to graphics processor hardware for a draw reference counter associated with resource descriptors tracked by software. The resource may be used through a descriptor object, and the hardware pipelines increment a related draw reference once per rendering/compute command (e.g., draw call, compute shader dispatch, etc.) when the descriptor object is read for the current draws resource access (e.g., when the descriptor is being tracked). This technique tracks actual hardware pipeline usage and may provide a better indication for resource priority across rendering/compute commands. For instance, regarding such priority, aspects utilize the number of descriptors/commands accessed, via counters, rather than a number of associated bytes in a memory that are read/written.

Aspects provide for descriptor based rendering and compute command reference counters. Various types of reference counters may be associated with entries of a profile descriptor data structure (e.g., a profile descriptor table, such as a high level sequencer (HLSQ) remapping table that maps profile descriptors to memory addresses, which may be a hardware table of descriptors that a graphics driver uses to profile and/or collect counter information, and such a hardware table may be programed by the graphics driver, may include descriptor information for hardware to perform a table lookup when a descriptor is loaded into hardware, and for which a table hit may trigger profiling of a corresponding descriptor). The reference counters may be updated based on accesses associated with shader resources for a given surface, as well as rendering and compute commands executed in association with the shader resource access. Each profile descriptor data structure entry may include a bit for a residency indication, e.g., the descriptor resides in system memory or in local memory for descriptor loading and accesses. In aspects, a system memory entry will not do base remapping, but rather will collect the reference counters, while the local memory may do both base remapping and reference counter collection. Accordingly, aspects enable reference counters and supporting mechanisms to provide guidance of which surface has higher priority to be brought into local memory.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

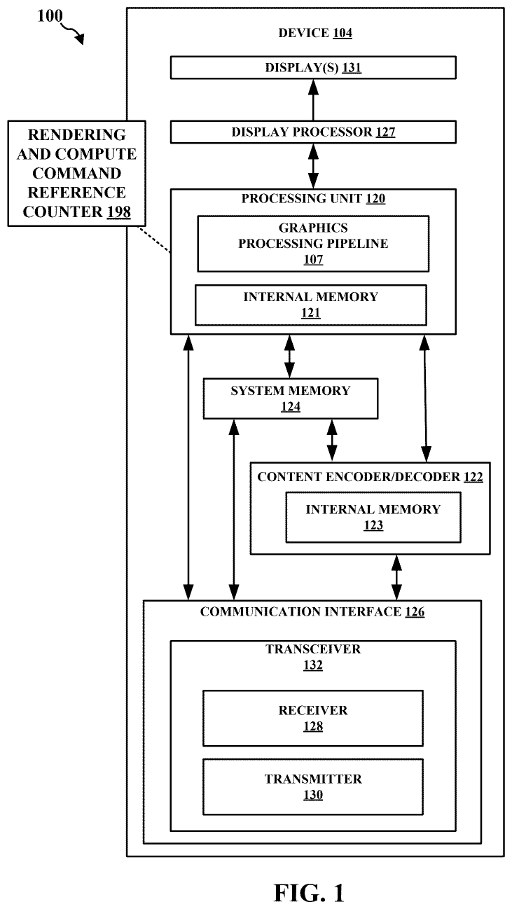

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a rendering and compute command reference counter 198 configured to receive an access indication indicative of an access, to a profile descriptor data structure, for a descriptor associated with a set of rendering and compute commands for a shader resource, to update, based on the access indication, a descriptor count value of a descriptor reference counter that corresponds to the descriptor, and to output, for a graphics driver, an indication of the descriptor count value. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

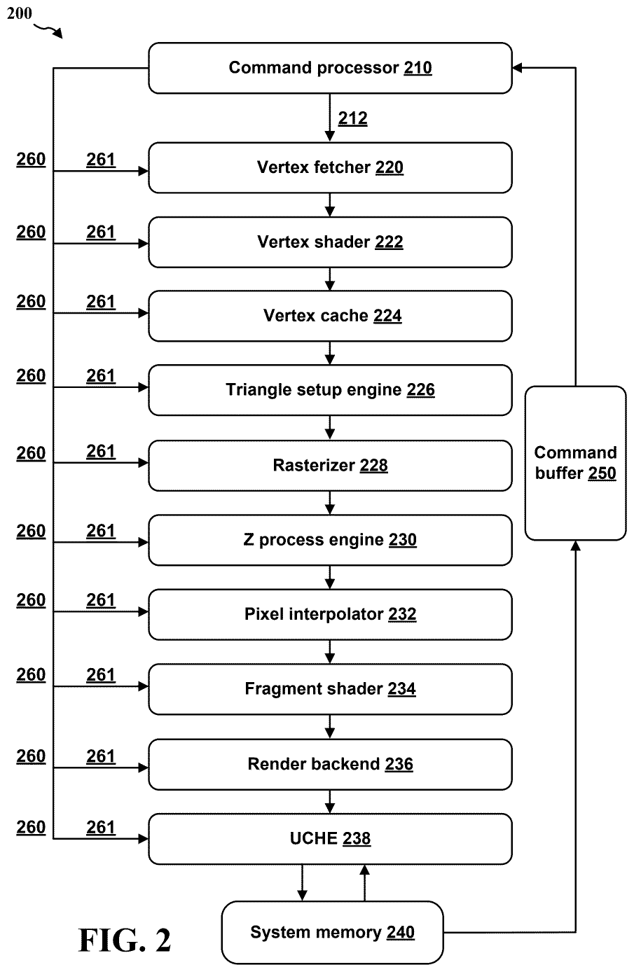

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

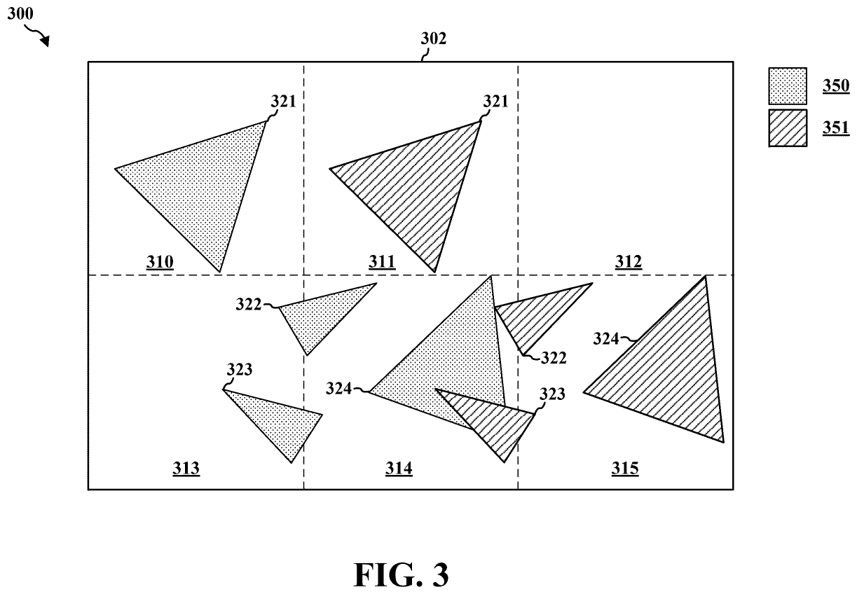

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

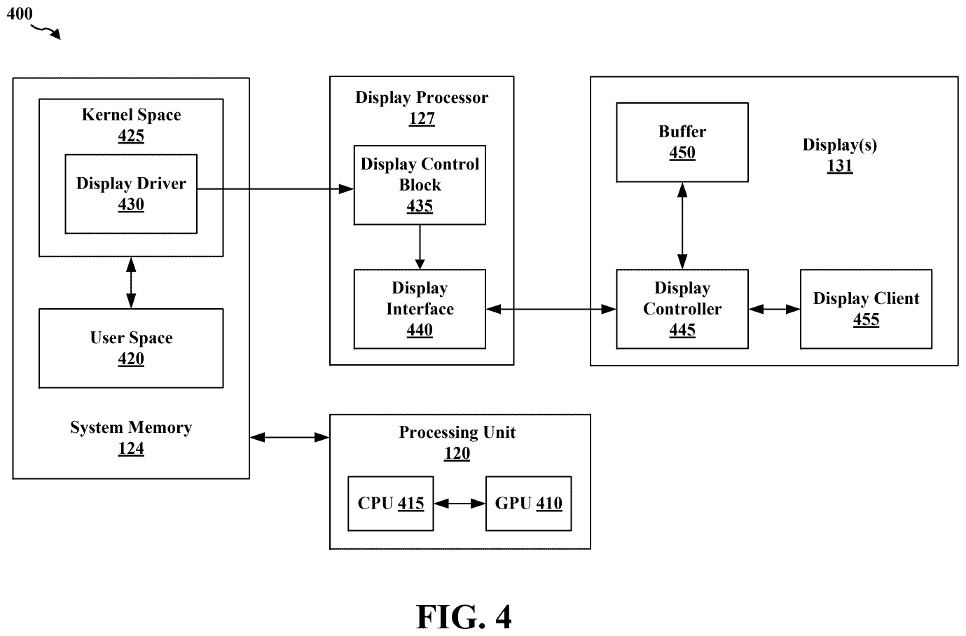

FIG. 4 is a block diagram 400 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 410 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 410 may be controlled based on one or more graphics processing commands provided by a CPU 415. The CPU 415 may be configured to execute multiple applications concurrently. In some cases, each of the concurrently executed multiple applications may utilize the GPU 410 simultaneously. Processing techniques may be performed via the processing unit 120 output a frame over physical or wireless communication channels.

The system memory 124, which may be executed by the processing unit 120, may include a user space 420 and a kernel space 425. The user space 420 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 425 may further include a display driver 430. The display driver 430 may be configured to control the display processor 127. For example, the display driver 430 may cause the display processor 127 to compose a frame and transmit the data for the frame to a display.

The display processor 127 includes a display control block 435 and a display interface 440. The display processor 127 may be configured to manipulate functions of the display(s) 131 (e.g., based on an input received from the display driver 430). The display control block 435 may be further configured to output image frames to the display(s) 131 via the display interface 440. In some examples, the display control block 435 may additionally or alternatively perform post-processing of image data provided based on execution of the system memory 124 by the processing unit 120.

The display interface 440 may be configured to cause the display(s) 131 to display image frames. The display interface 440 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 450.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 450. For example, when a Vsync pulse is generated, the display processor 127 may output new graphical content to the buffer 450. Thus, generation of the Vsync pulse may indicate that current graphical content has been rendered at the buffer 450.

Frames are displayed at the display(s) 131 based on a display controller 445, a display client 455, and the buffer 450. The display controller 445 may receive image data from the display interface 440 and store the received image data in the buffer 450. In some examples, the display controller 445 may output the image data stored in the buffer 450 to the display client 455. Thus, the buffer 450 may represent a local memory to the display(s) 131. In some examples, the display controller 445 may output the image data received from the display interface 440 directly to the display client 455.

The display client 455 may be associated with a touch panel that senses interactions between a user and the display(s) 131. As the user interacts with the display(s) 131, one or more sensors in the touch panel may output signals to the display controller 445 that indicate which of the one or more sensors have sensor activity, a duration of the sensor activity, an applied pressure to the one or more sensor, etc. The display controller 445 may use the sensor outputs to determine a manner in which the user has interacted with the display(s) 131. The display(s) 131 may be further associated with/include other devices, such as a camera, a microphone, and/or a speaker, that operate in connection with the display client 455.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 410 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

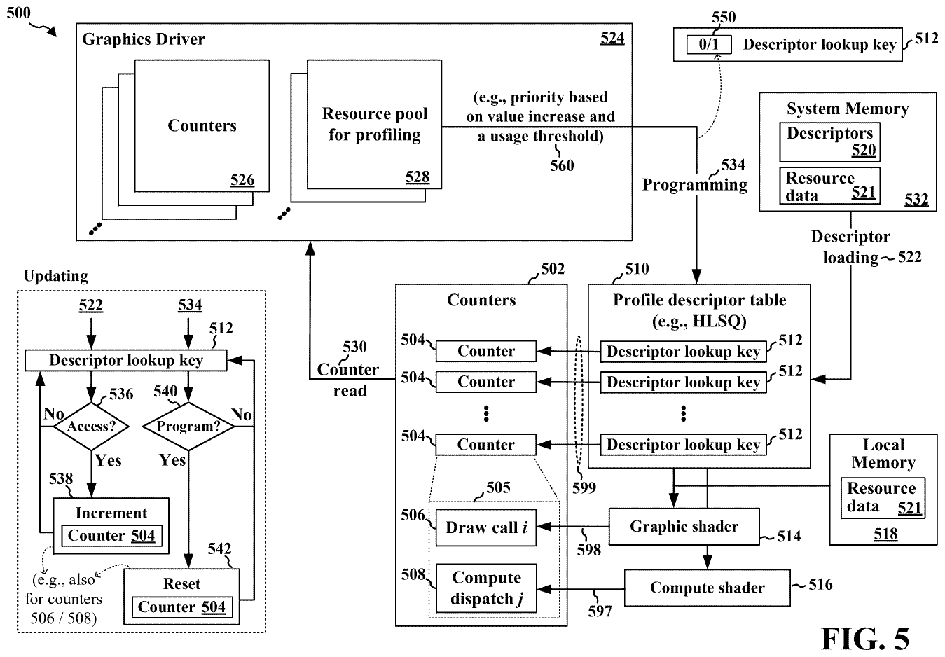

FIG. 5 illustrates a diagram 500 of an example architecture for descriptor based rendering and compute command reference counters in accordance with one or more techniques of this disclosure. Diagram 500 is shown in the context of a set of reference counters 502 and an associated profile descriptor data structure 510 (e.g., a profile descriptor table, such as an HLSQ remapping table) having a set of descriptors associated with a set of rendering and compute commands for shader resources.

In aspects, the set of reference counters 502 may include a number of instances (e.g., a set) of a descriptor reference counters 504 corresponding to a number of instances of a descriptor lookup key 512 of the profile descriptor data structure 510. The set of reference counters 502 may include a number (e.g., a set) of command reference counters 505. Each of the command reference counters may include a draw call command counter 506 associated with a rendering command (e.g., a graphic rendering draw call executed by a graphic shader 514), a compute dispatch counter 508 associated with a compute command (e.g., a compute shader dispatch executed by a compute shader 516), and/or the like. Counters of the set of reference counters 502 may be updated (e.g., incremented/reset) according to conditions described herein. For example, instances of the descriptor reference counters 504 may be configured to increment based on an access indication 599 of an access to a shader resource associated with the corresponding instance of the descriptor lookup key 512. Likewise, instances of the command reference counters 505, the draw call command counter 506 may be configured to increment based on indications 598, and/or the compute dispatch counter 508 may be configured to increment based on indications 597, for each rendering command/compute command executed in association with the shader resource that corresponds to the descriptor lookup key 512 and associated instance of the descriptor reference counters 504. That is, for each access to a shader resource (e.g., based on an appropriate descriptor lookup key 512), a corresponding instance of the descriptor reference counters 504 may be configured to increment, while corresponding instances of the command reference counters 505, the draw call command counter 506, and/or the compute dispatch counter 508 may be configured to increment zero or more times for each time the associated instance of the descriptor reference counters 504 is incremented. In this way, surface level access of shader resources and corresponding command usage may be tracked (e.g., tracked by graphics processing hardware).

As one example, for a given instance of the descriptor lookup key 512, descriptor loading 522 for the instance of the descriptor lookup key 512 may be determined (at 536) as an access for an associated shader resource. In such a case, a corresponding instance of the descriptor reference counters 504 may be incremented (at 538) by a graphics processor. Similarly, programming (at 534) (e.g., a programming update) for the instance of the descriptor lookup key 512 (e.g., as applied to the profile descriptor data structure 510) may be determined (at 540) as a reset indication for the set of reference counters, including the corresponding instance of the descriptor reference counters 504, and the instance of the descriptor reference counters 504 may be reset (at 542) by the graphics processor. While not shown for illustrative clarity and brevity of description, instances of the command reference counters 505 (e.g., including the respective draw call command counter 506 and the respective compute dispatch counter 508) may be similarly incremented and/or reset as described herein for the corresponding instance of the descriptor reference counters 504.

With reference to updating the set of reference counters 502 by resetting values thereof, a graphics driver 524 may track values of the set of reference counters 502 via counters 526. The counters 526 may be updated based on a counter read 530, e.g., an output(s) (e.g., by the graphics processor), of values for various ones of the set of reference counters 502. The graphics driver 524 may be configured to manage a resource pool 528 for profiling, and may be configured to program (at 534) the profile descriptor data structure 510 with updated instances of the descriptor lookup key 512 (e.g., as profiling candidate descriptor addresses for respective instances thereof). The programming (at 534) may be performed via the resource pool 528 of the graphics driver 524 based on priorities of shader resources. Higher priority shader resources may be stored in a local memory 518 (e.g., GMEM) according to associated descriptors 520 for descriptor loading 522 utilized by rendering and compute commands, while lower priority shader resources may be stored in a system memory 532 for the descriptor loading 522 utilized by rendering and compute commands. The priorities may be based on value increases for instances of the set of reference counters 502 and a usage threshold 560 (e.g., at a maximum counter value of a reference counter or at a value (e.g., half the maximum counter value, a discrete value such as 100, etc.)) that is greater than, or greater than/equal to, the usage threshold 560, the shader resource (e.g., a surface) may be deemed of a high enough priority to be stored in the local memory 518) for a current application. The programming (at 534) may adjust residence bits (e.g., for local memory 518 or system memory 532 residence) of the profile descriptor data structure 510 based on such priorities, while initially, the profile descriptor data structure 510 may be programmed based on estimation or configuration values. In aspects, each profile descriptor data structure 510 entry (e.g., instances of the descriptor lookup key 512) may include a bit for a residency indication 550, e.g., resource data 521 of the descriptor resides in the system memory 532 (e.g., a bit value of 0/1) or in the local memory 518 (e.g., a bit value of 1/0) based on its determined residence, for which the descriptor loading 522 may be based to obtain addresses of resource data 521 in the appropriate memory of residence. The residency indication 550 may be set/reset during the programming (at 534), in aspects.

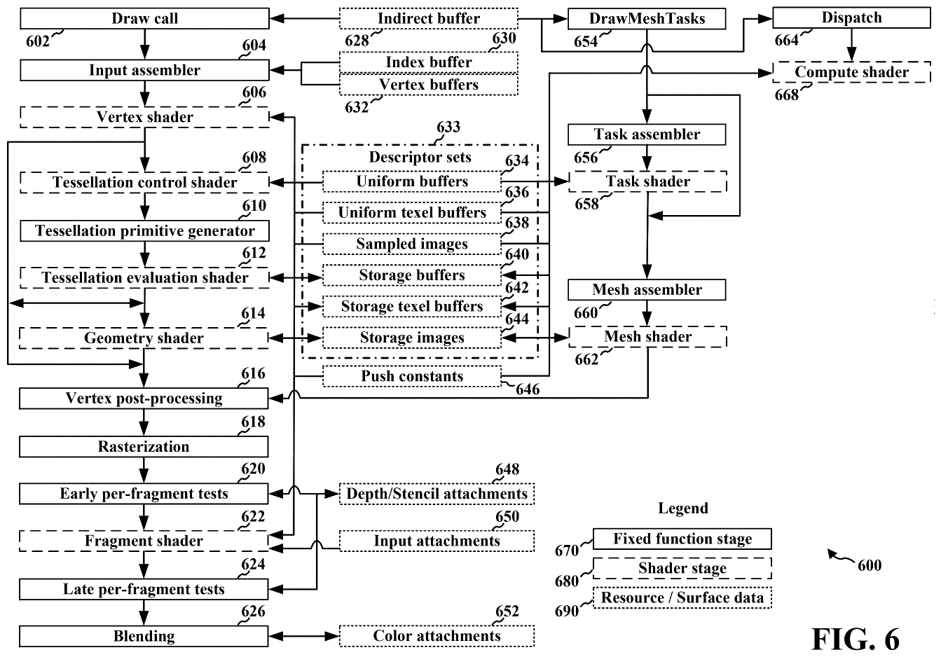

FIG. 6 illustrates a diagram 600 of examples of functions, shaders, and resources for descriptor based rendering and compute command reference counters in accordance with one or more techniques of this disclosure. In aspects, a descriptor may be an opaque data structure representing a shader resource, such as but without limitation, a buffer, a buffer view, an image view, a sampler, a combined image sampler, and/or the like. Diagram 600 is shown in the context of fixed function stages 670, shader stages 680, and shader resources 690 that may include surface data, in various aspects. One example of the communication between stages, or the flow of data between different stages or components in FIG. 6, is shown in diagram 600. For example, draw call 602 may communicate/send data to input assembler 604, as well as communicate/receive data from indirect buffer 628.

Examples of the fixed function stages 670 may include the draw call 602, an input assembler 604, a tessellation primitive generator 610, vertex post-processing 616, rasterization 618, early per-fragment tests 620, late per-fragment tests 624, blending 626, DrawMeshTasks 654, a task assembler 656, a mesh assembler 660, a dispatcher 664, and/or the like.

Examples of the shader stages 680 may include a vertex shader 606, a tessellation control shader 608, a tessellation evaluation shader 612, a geometry shader 614, a fragment shader 622, a task shader 658, a mesh shader 662, a compute shader 668, and/or the like.

Examples of the shader resources 690 may include an indirect buffer 628, an index buffer 630, vertex buffers 632, descriptor sets 633 (which may include uniform buffers 634, uniform texel buffers 636, sampled images 638, storage buffers 640, storage texel buffers 642, and storage images 644), push constants 646, depth/stencil attachments 648, input attachments 650, color attachments 652, and/or the like.

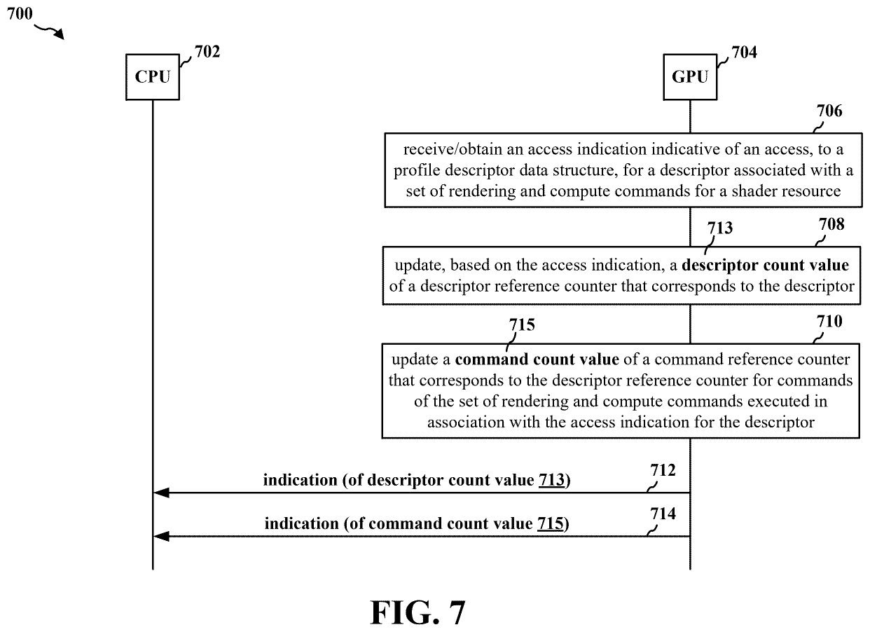

FIG. 7 is a call flow diagram 700 illustrating example communications between a CPU 702 and a graphics processor 704 in accordance with one or more techniques of this disclosure. In aspects, call flow diagram 700 is described for descriptor based rendering and compute command reference counters. In an example, the graphics processor 704 may be or include the processing unit 120/the rendering and compute command reference counter 198. In aspects, the graphics processor 704 comprises a wireless communication device that is configured to perform the call flow diagram 700.

At 706, the graphics processor 704 receives/obtains an access indication indicative of an access, to a profile descriptor data structure, for a descriptor associated with a set of rendering and compute commands for a shader resource. In aspects, the profile descriptor data structure may be a HLSQ remapping table that includes at least one of a descriptor lookup key or an address associated with the descriptor. In aspects, the descriptor associated with the set of rendering and compute commands for the shader resource may be indicative of at least one of a buffer, a buffer view, an image view, a sampler, a combined image sampler, and/or the like. In some aspects, the descriptor may be one of a set of descriptors, and the set of descriptors may correspond to a set of shader resources accessible for the set of rendering and compute commands. The shader resource may include surface data associated with a surface for image data. In aspects, the shader resource may be stored, in association with an execution of one or more commands of the set of rendering and compute commands, at a local memory or at a system memory based on the descriptor count value 713. In some aspects, a value increase of the descriptor count value 713 corresponds to a priority increase of a priority associated with the shader resource, and the shader resource may be stored in the local memory based on the value increase and a usage threshold (e.g., at a maximum counter value of a descriptor reference counter or at a value that is greater than, or greater than/equal to, the usage threshold, the shader resource may be deemed of a high enough priority to be stored in the local memory). In some aspects, the shader resource may be stored, in association with execution of one or more commands of the set of rendering and compute commands, at the local memory or at the system memory based on the command count value 715, e.g., as similarly noted above for the descriptor count value 713 (e.g., at a maximum counter value of a command reference counter or at a value that is greater than, or greater than/equal to, the usage threshold, the shader resource may be deemed of a high enough priority to be stored in the local memory). In some aspects, a rendering command for the shader resource may be associated with a graphic rendering draw call for image data at a surface level. In some aspects, a compute command for the shader resource may be associated with a compute shader dispatch for image data at a surface level.

At 708, the graphics processor 704 updates, based on the access indication, a descriptor count value 713 of a descriptor reference counter that corresponds to the descriptor. In aspects, to update the descriptor count value 713, the graphics processor 704 may be configured to increment the descriptor count value 713 based on the access indication. In aspects, to update the descriptor count value 713, the graphics processor 704 may be configured to reset the descriptor count value 713 based on a programming update to the profile descriptor data structure. In some aspects, the descriptor reference counter may be one of a set of descriptor reference counters, and each descriptor reference counter in the set of descriptor reference counters may respectively correspond to each shader resource of a set of shader resources.

At 710, the graphics processor 704 updates a command count value 715 of a command reference counter that corresponds to the descriptor reference counter for commands of the set of rendering and compute commands executed in association with the access indication for the descriptor. In aspects, to update the command count value 715, the graphics processor 704 may be configured to increment the command count value 715 based on a number of the commands of the set of rendering and compute commands executed. In aspects, to update the command count value 715, the graphics processor 704 may be configured to reset the command count value 715 based on a programming update to the profile descriptor data structure. In aspects, the command reference counter may be one of a set of command reference counters and the descriptor reference counter may be one of a set of descriptor reference counters. In such aspects, each command reference counter in the set of command reference counters may respectively correspond to each descriptor reference counter.

The graphics processor 704 may be configured to output (e.g., transmit/provide), and the CPU 702 may be configured to receive, an indication 712 of the descriptor count value 713 (e.g., for a graphics driver). In aspects, to output the descriptor count value 713, the graphics processor 704 may be configured to store the descriptor count value 713 in memory and/or to provide the descriptor count value 713 to the graphics driver (e.g., at the CPU 702).

The graphics processor 704 may be configured to output (e.g., transmit/provide), and the CPU 702 may be configured to receive, another indication (e.g., an indication 714) of the command count value 715 (e.g., for the graphics driver). In aspects, to output the command count value, the graphics processor 704 may be configured to store the command count value in memory and/or to provide the command count value to the graphics driver (e.g., at the CPU 702).

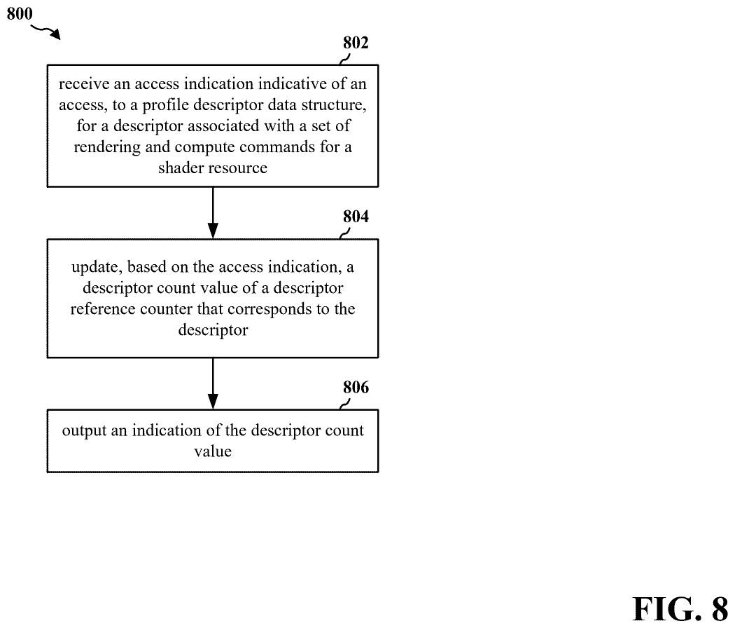

FIG. 8 is a flowchart 800 of an example method of graphics processing in accordance with one or more techniques of this disclosure. The method may be performed by an apparatus, such as an apparatus for graphics processing, a graphics processor (e.g., a GPU), a central processor (e.g., a CPU), a wireless communication device, and the like, as used in connection with any of the aspects of FIGS. 1-7.

At 802, the apparatus may receive an access indication indicative of an access, to a profile descriptor data structure, for a descriptor associated with a set of rendering and compute commands for a shader resource. For example, referring to FIG. 7, at 706, the graphics processor 704 receives/obtains an access indication (e.g., 599 in FIG. 5) indicative of an access, to a profile descriptor data structure (e.g., 510 in FIG. 5), for a descriptor (e.g., 520 in FIG. 5) associated with a set of rendering and compute commands (e.g., 670 in FIG. 6) for a shader resource (e.g., 690 in FIG. 6). In aspects, the profile descriptor data structure (e.g., 510 in FIG. 5) may be a HLSQ remapping table that includes at least one of a descriptor lookup key (e.g., 512 in FIG. 5) or an address associated with the descriptor (e.g., 520 in FIG. 5). In aspects, the descriptor (e.g., 520 in FIG. 5) associated with the set of rendering and compute commands (e.g., 670 in FIG. 6) for the shader resource (e.g., 690 in FIG. 6) may be indicative of at least one of a buffer, a buffer view, an image view, a sampler, a combined image sampler, and/or the like. In some aspects, the descriptor (e.g., 520 in FIG. 5) may be one of a set of descriptors (e.g., 520 in FIG. 5), and the set of descriptors (e.g., 520 in FIG. 5) may correspond to a set of shader resources (e.g., 690 in FIG. 6) accessible for the set of rendering and compute commands (e.g., 670 in FIG. 6). The shader resource (e.g., 690 in FIG. 6) may include surface data (e.g., 690 in FIG. 6) associated with a surface for image data. In aspects, the shader resource (e.g., 690 in FIG. 6) may be stored, in association with an execution of one or more commands of the set of rendering and compute commands (e.g., 670 in FIG. 6), at a local memory (e.g., 518 in FIG. 5) or at a system memory (e.g., 532 in FIG. 5) based on the descriptor count value 713 (e.g., of 504 in FIG. 5). In some aspects, a value increase of the descriptor count value 713 (e.g., of 504 in FIG. 5) corresponds to a priority increase of a priority associated with the shader resource (e.g., 690 in FIG. 6), and the shader resource (e.g., 690 in FIG. 6) may be stored in the local memory (e.g., 518 in FIG. 5) based on the value increase and a usage threshold 560 (e.g., at a maximum counter value of a descriptor reference counter (e.g., 504 in FIG. 5) or at a value that is greater than, or greater than/equal to, the usage threshold 560, the shader resource (e.g., 690 in FIG. 6) may be deemed of a high enough priority to be stored in the local memory (e.g., 518 in FIG. 5)). In some aspects, the shader resource (e.g., 690 in FIG. 6) may be stored, in association with execution of one or more commands of the set of rendering and compute commands (e.g., 670 in FIG. 6), at the local memory (e.g., 518 in FIG. 5) or at the system memory (e.g., 532 in FIG. 5) based on the command count value 715 (e.g., of 505, 506, 508 in FIG. 5), e.g., as similarly noted above for the descriptor count value 713 (e.g., of 504 in FIG. 5) (e.g., at a maximum counter value of a command reference counter (e.g., 505, 506, 508 in FIG. 5) or at a value that is greater than, or greater than/equal to, the usage threshold 560, the shader resource (e.g., 690 in FIG. 6) may be deemed of a high enough priority to be stored in the local memory (e.g., 518 in FIG. 5)). In some aspects, a rendering command for the shader resource (e.g., 690 in FIG. 6) may be associated with a graphic rendering draw call (e.g., 602 in FIG. 6) for image data at a surface level. In some aspects, a compute command for the shader resource (e.g., 690 in FIG. 6) may be associated with a compute shader dispatch (e.g., 664 in FIG. 6) for image data at a surface level. In an example, 802 may be performed by the rendering and compute command reference counter 198.

At 804, the apparatus may update, based on the access indication, a descriptor count value of a descriptor reference counter that corresponds to the descriptor. For example, referring to FIG. 7, at 708, the graphics processor 704 updates, based on the access indication, a descriptor count value 713 (e.g., of 504 in FIG. 5) of a descriptor reference counter (e.g., 504 in FIG. 5) that corresponds to the descriptor (e.g., 520 in FIG. 5). In aspects, to update the descriptor count value 713 (e.g., of 504 in FIG. 5), the graphics processor 704 may be configured to increment (e.g., at 536/538 in FIG. 5) the descriptor count value 713 (e.g., of 504 in FIG. 5) based on the access indication. In aspects, to update the descriptor count value 713 (e.g., of 504 in FIG. 5), the graphics processor 704 may be configured to reset (e.g., at 540/542 in FIG. 5) the descriptor count value 713 (e.g., of 504 in FIG. 5) based on a programming update (e.g., at 534 in FIG. 5) to the profile descriptor data structure (e.g., 510 in FIG. 5). In some aspects, the descriptor reference counter (e.g., 504 in FIG. 5) may be one of a set of descriptor reference counters (e.g., 504 in FIG. 5), and each descriptor reference counter (e.g., 504 in FIG. 5) in the set of descriptor reference counters (e.g., 504 in FIG. 5) may respectively correspond to each shader resource of a set of shader resources (e.g., 690 in FIG. 6). Additionally, at 710, the graphics processor 704 updates a command count value 715 (e.g., of 505, 506, 508 in FIG. 5) of a command reference counter (e.g., 505, 506, 508 in FIG. 5) that corresponds to the descriptor reference counter (e.g., 504 in FIG. 5) for commands of the set of rendering and compute commands (e.g., 670 in FIG. 6) executed in association with the access indication (e.g., at 599 in FIG. 5) for the descriptor (e.g., 520 in FIG. 5). In aspects, to update the command count value 715 (e.g., of 505, 506, 508 in FIG. 5), the graphics processor 704 may be configured to increment (e.g., at 536/538 in FIG. 5) the command count value 715 (e.g., of 505, 506, 508 in FIG. 5) based on a number of the commands of the set of rendering and compute commands (e.g., 670 in FIG. 6) executed (e.g., via 597, 598 in FIG. 5). In aspects, to update the command count value 715 (e.g., of 505, 506, 508 in FIG. 5), the graphics processor 704 may be configured to reset (e.g., at 540/542 in FIG. 5) the command count value 715 (e.g., of 505, 506, 508 in FIG. 5) based on a programming update (e.g., at 534 in FIG. 5) to the profile descriptor data structure (e.g., 510 in FIG. 5). In aspects, the command reference counter (e.g., 505, 506, 508 in FIG. 5) may be one of a set of command reference counters (e.g., 505, 506, 508 in FIG. 5) and the descriptor reference counter (e.g., 504 in FIG. 5) may be one of a set of descriptor reference counters (e.g., 504 in FIG. 5). In such aspects, each command reference counter (e.g., 505, 506, 508 in FIG. 5) in the set of command reference counters (e.g., 505, 506, 508 in FIG. 5) may respectively correspond to each descriptor reference counter (e.g., 504 in FIG. 5). In an example, 804 may be performed by the rendering and compute command reference counter 198.

At 806, the apparatus may output, for a graphics driver, an indication of the descriptor count value. For example, referring to FIG. 7, the graphics processor 704 may be configured to output (e.g., transmit/provide), and the CPU 702 may be configured to receive, an indication 712 (e.g., via 530 in FIG. 5) of the descriptor count value 713 (e.g., of 504 in FIG. 5) (e.g., for a graphics driver (e.g., 524 in FIG. 5)). In aspects, to output (e.g., via 530 in FIG. 5) the descriptor count value 713 (e.g., of 504 in FIG. 5), the graphics processor 704 may be configured to store the descriptor count value 713 (e.g., of 504 in FIG. 5) in memory and/or to provide the descriptor count value 713 (e.g., of 504 in FIG. 5) to the graphics driver (e.g., 524 in FIG. 5) (e.g., at the CPU 702). The graphics processor 704 may also be configured to output (e.g., transmit/provide), and the CPU 702 may be configured to receive, another indication (e.g., an indication 714 (e.g., via 530 in FIG. 5)) of the command count value 715 (e.g., of 505, 506, 508 in FIG. 5) (e.g., for the graphics driver (e.g., 524 in FIG. 5)). In aspects, to output (e.g., via 530 in FIG. 5) the command count value 715 (e.g., of 505, 506, 508 in FIG. 5), the graphics processor 704 may be configured to store the command count value 715 (e.g., of 505, 506, 508 in FIG. 5) in memory and/or to provide the command count value 715 (e.g., of 505, 506, 508 in FIG. 5) to the graphics driver (e.g., 524 in FIG. 5) (e.g., at the CPU 702). In an example, 806 may be performed by the rendering and compute command reference counter 198.

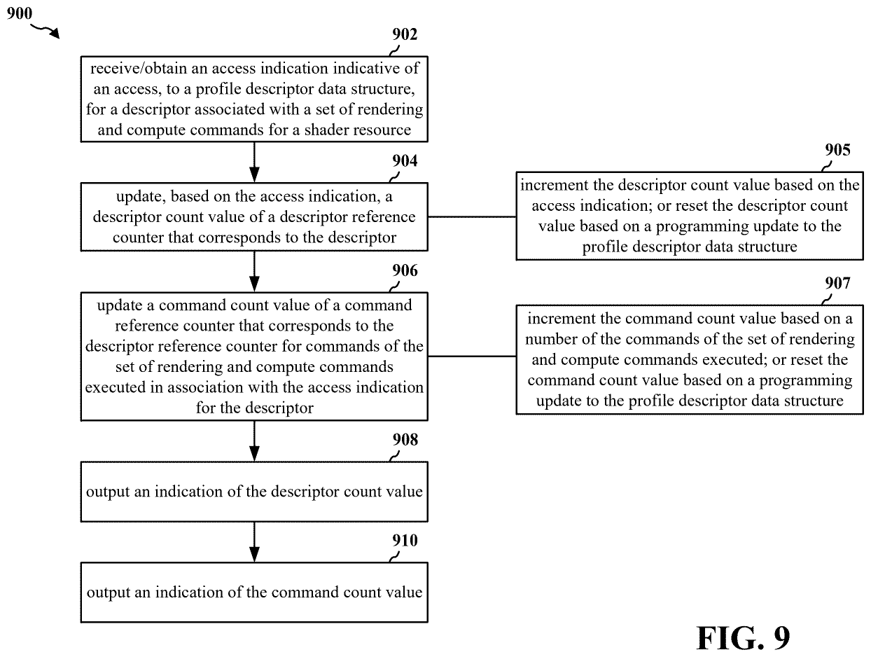

FIG. 9 is a flowchart 900 of an example method of graphics processing in accordance with one or more techniques of this disclosure. The method may be performed by an apparatus, such as an apparatus for graphics processing, a graphics processor (e.g., a GPU), a central processor (e.g., a CPU), a wireless communication device, and the like, as used in connection with any of the aspects of FIGS. 1-7.

At 902, the apparatus may receive an access indication indicative of an access, to a profile descriptor data structure, for a descriptor associated with a set of rendering and compute commands for a shader resource. For example, referring to FIG. 7, at 706, the graphics processor 704 receives/obtains an access indication (e.g., 599 in FIG. 5) indicative of an access, to a profile descriptor data structure (e.g., 510 in FIG. 5), for a descriptor (e.g., 520 in FIG. 5) associated with a set of rendering and compute commands (e.g., 670 in FIG. 6) for a shader resource (e.g., 690 in FIG. 6). In aspects, the profile descriptor data structure (e.g., 510 in FIG. 5) may be a HLSQ remapping table that includes at least one of a descriptor lookup key (e.g., 512 in FIG. 5) or an address associated with the descriptor (e.g., 520 in FIG. 5). In aspects, the descriptor (e.g., 520 in FIG. 5) associated with the set of rendering and compute commands (e.g., 670 in FIG. 6) for the shader resource (e.g., 690 in FIG. 6) may be indicative of at least one of a buffer, a buffer view, an image view, a sampler, a combined image sampler, and/or the like. In some aspects, the descriptor (e.g., 520 in FIG. 5) may be one of a set of descriptors (e.g., 520 in FIG. 5), and the set of descriptors (e.g., 520 in FIG. 5) may correspond to a set of shader resources (e.g., 690 in FIG. 6) accessible for the set of rendering and compute commands (e.g., 670 in FIG. 6). The shader resource (e.g., 690 in FIG. 6) may include surface data (e.g., 690 in FIG. 6) associated with a surface for image data. In aspects, the shader resource (e.g., 690 in FIG. 6) may be stored, in association with an execution of one or more commands of the set of rendering and compute commands (e.g., 670 in FIG. 6), at a local memory (e.g., 518 in FIG. 5) or at a system memory (e.g., 532 in FIG. 5) based on the descriptor count value 713 (e.g., of 504 in FIG. 5). In some aspects, a value increase of the descriptor count value 713 (e.g., of 504 in FIG. 5) corresponds to a priority increase of a priority associated with the shader resource (e.g., 690 in FIG. 6), and the shader resource (e.g., 690 in FIG. 6) may be stored in the local memory (e.g., 518 in FIG. 5) based on the value increase and a usage threshold 560 (e.g., at a maximum counter value of a descriptor reference counter (e.g., 504 in FIG. 5) or at a value that is greater than, or greater than/equal to, the usage threshold 560, the shader resource (e.g., 690 in FIG. 6) may be deemed of a high enough priority to be stored in the local memory (e.g., 518 in FIG. 5)). In some aspects, the shader resource (e.g., 690 in FIG. 6) may be stored, in association with execution of one or more commands of the set of rendering and compute commands (e.g., 670 in FIG. 6), at the local memory (e.g., 518 in FIG. 5) or at the system memory (e.g., 532 in FIG. 5) based on the command count value 715 (e.g., of 505, 506, 508 in FIG. 5), e.g., as similarly noted above for the descriptor count value 713 (e.g., of 504 in FIG. 5) (e.g., at a maximum counter value of a command reference counter (e.g., 505, 506, 508 in FIG. 5) or at a value that is greater than, or greater than/equal to, the usage threshold 560, the shader resource (e.g., 690 in FIG. 6) may be deemed of a high enough priority to be stored in the local memory (e.g., 518 in FIG. 5)). In some aspects, a rendering command for the shader resource (e.g., 690 in FIG. 6) may be associated with a graphic rendering draw call (e.g., 602 in FIG. 6) for image data at a surface level. In some aspects, a compute command for the shader resource (e.g., 690 in FIG. 6) may be associated with a compute shader dispatch (e.g., 664 in FIG. 6) for image data at a surface level. In an example, 902 may be performed by the rendering and compute command reference counter 198.

At 904, the apparatus may update, based on the access indication, a descriptor count value of a descriptor reference counter that corresponds to the descriptor. For example, referring to FIG. 7, at 708, the graphics processor 704 updates, based on the access indication, a descriptor count value 713 (e.g., of 504 in FIG. 5) of a descriptor reference counter (e.g., 504 in FIG. 5) that corresponds to the descriptor (e.g., 520 in FIG. 5). In aspects, to update the descriptor count value 713 (e.g., of 504 in FIG. 5), the graphics processor 704 may be configured to increment (e.g., at 536/538 in FIG. 5) the descriptor count value 713 (e.g., of 504 in FIG. 5) based on the access indication. In aspects, to update the descriptor count value 713 (e.g., of 504 in FIG. 5), the graphics processor 704 may be configured to reset (e.g., at 540/542 in FIG. 5) the descriptor count value 713 (e.g., of 504 in FIG. 5) based on a programming update (e.g., at 534 in FIG. 5) to the profile descriptor data structure (e.g., 510 in FIG. 5). In some aspects, the descriptor reference counter (e.g., 504 in FIG. 5) may be one of a set of descriptor reference counters (e.g., 504 in FIG. 5), and each descriptor reference counter (e.g., 504 in FIG. 5) in the set of descriptor reference counters (e.g., 504 in FIG. 5) may respectively correspond to each shader resource of a set of shader resources (e.g., 690 in FIG. 6). In an example, 904 may be performed by the rendering and compute command reference counter 198.

At 906, the apparatus may update a command count value of a command reference counter that corresponds to the descriptor reference counter for commands of the set of rendering and compute commands executed in association with the access indication for the descriptor. For example, referring to FIG. 7, at 710, the graphics processor 704 updates a command count value 715 (e.g., of 505, 506, 508 in FIG. 5) of a command reference counter (e.g., 505, 506, 508 in FIG. 5) that corresponds to the descriptor reference counter (e.g., 504 in FIG. 5) for commands of the set of rendering and compute commands (e.g., 670 in FIG. 6) executed in association with the access indication (e.g., at 599 in FIG. 5) for the descriptor (e.g., 520 in FIG. 5). In aspects, to update the command count value 715 (e.g., of 505, 506, 508 in FIG. 5), the graphics processor 704 may be configured to increment (e.g., at 536/538 in FIG. 5) the command count value 715 (e.g., of 505, 506, 508 in FIG. 5) based on a number of the commands of the set of rendering and compute commands (e.g., 670 in FIG. 6) executed (e.g., via 597, 598 in FIG. 5). In aspects, to update the command count value 715 (e.g., of 505, 506, 508 in FIG. 5), the graphics processor 704 may be configured to reset (e.g., at 540/542 in FIG. 5) the command count value 715 (e.g., of 505, 506, 508 in FIG. 5) based on a programming update (e.g., at 534 in FIG. 5) to the profile descriptor data structure (e.g., 510 in FIG. 5). In aspects, the command reference counter (e.g., 505, 506, 508 in FIG. 5) may be one of a set of command reference counters (e.g., 505, 506, 508 in FIG. 5) and the descriptor reference counter (e.g., 504 in FIG. 5) may be one of a set of descriptor reference counters (e.g., 504 in FIG. 5). In such aspects, each command reference counter (e.g., 505, 506, 508 in FIG. 5) in the set of command reference counters (e.g., 505, 506, 508 in FIG. 5) may respectively correspond to each descriptor reference counter (e.g., 504 in FIG. 5). In an example, 906 may be performed by the rendering and compute command reference counter 198.

At 908, the apparatus may output, for a graphics driver, an indication of the descriptor count value. For example, referring to FIG. 7, the graphics processor 704 may be configured to output (e.g., transmit/provide), and the CPU 702 may be configured to receive, an indication 712 (e.g., via 530 in FIG. 5) of the descriptor count value 713 (e.g., of 504 in FIG. 5) (e.g., for a graphics driver (e.g., 524 in FIG. 5)). In aspects, to output (e.g., via 530 in FIG. 5) the descriptor count value 713 (e.g., of 504 in FIG. 5), the graphics processor 704 may be configured to store the descriptor count value 713 (e.g., of 504 in FIG. 5) in memory and/or to provide the descriptor count value 713 (e.g., of 504 in FIG. 5) to the graphics driver (e.g., 524 in FIG. 5) (e.g., at the CPU 702). In an example, 908 may be performed by the rendering and compute command reference counter 198.

At 910, the apparatus may output, for a graphics driver, an indication of the command count value. For example, referring to FIG. 7, the graphics processor 704 may also be configured to output (e.g., transmit/provide), and the CPU 702 may be configured to receive, another indication (e.g., an indication 714 (e.g., via 530 in FIG. 5)) of the command count value 715 (e.g., of 505, 506, 508 in FIG. 5) (e.g., for the graphics driver (e.g., 524 in FIG. 5)). In aspects, to output (e.g., via 530 in FIG. 5) the command count value 715 (e.g., of 505, 506, 508 in FIG. 5), the graphics processor 704 may be configured to store the command count value 715 (e.g., of 505, 506, 508 in FIG. 5) in memory and/or to provide the command count value 715 (e.g., of 505, 506, 508 in FIG. 5) to the graphics driver (e.g., 524 in FIG. 5) (e.g., at the CPU 702). In an example, 910 may be performed by the rendering and compute command reference counter 198.

In configurations, a method or an apparatus for graphics processing is provided. The apparatus may be a graphics processor (e.g., a GPU), a central processor (e.g., a CPU), or some other processor that may perform graphics processing. In aspects, the apparatus may be the processing unit 120 within the device 104, or may be some other hardware within the device 104 or another device. The apparatus may include means for receiving an access indication indicative of an access, to a profile descriptor data structure, for a descriptor associated with a set of rendering and compute commands for a shader resource, means for updating, based on the access indication, a descriptor count value of a descriptor reference counter that corresponds to the descriptor, and means for outputting, for a graphics driver, an indication of the descriptor count value. The apparatus may further include means for updating a command count value of a command reference counter that corresponds to the descriptor reference counter for commands of the set of rendering and compute commands executed in association with the access indication for the descriptor, and means for outputting, for the graphics driver, another indication of the command count value. The apparatus may further include means for incrementing the descriptor count value based on the access indication and/or means for resetting the descriptor count value based on a programming update to the profile descriptor data structure. The apparatus may further include means for incrementing the command count value based on a number of the commands of the set of rendering and compute commands executed, and/or means for resetting the command count value based on a programming update to the profile descriptor data structure.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, comprising: receiving an access indication indicative of an access, to a profile descriptor data structure, for a descriptor associated with a set of rendering and compute commands for a shader resource; updating, based on the access indication, a descriptor count value of a descriptor reference counter that corresponds to the descriptor; and outputting an indication of the descriptor count value.

Aspect 2 is the method of aspect 1, wherein the profile descriptor data structure is a high level sequencer (HLSQ) remapping table that includes at least one of a descriptor lookup key or an address associated with the descriptor.

Aspect 3 is the method of any of aspects 1 and 2, wherein updating the descriptor count value includes: incrementing the descriptor count value based on the access indication; or resetting the descriptor count value based on a programming update to the profile descriptor data structure.

Aspect 4 is the method of any of aspects 1 to 3, wherein the descriptor associated with the set of rendering and compute commands for the shader resource is indicative of at least one of a buffer, a buffer view, an image view, a sampler, or a combined image sampler.

Aspect 5 is the method of any of aspects 1 to 4, wherein the shader resource is stored at a system memory based on the descriptor count value failing to meet a usage threshold.

Aspect 6 is the method of any of aspects 1 to 5, wherein the updated descriptor count value corresponds to an increase, wherein the shader resource is stored in a local memory based on the increase and a usage threshold being met.

Aspect 7 is the method of any of aspects 1 to 6, wherein the descriptor reference counter is one of a set of descriptor reference counters, wherein each descriptor reference counter in the set of descriptor reference counters respectively corresponds to each shader resource of a set of shader resources.

Aspect 8 is the method of any of aspects 1 to 7, further comprising: updating a command count value of a command reference counter that corresponds to the descriptor reference counter for commands of the set of rendering and compute commands executed in association with the access indication for the descriptor.

Aspect 9 is the method of aspect 8, wherein updating the command count value includes: incrementing the command count value based on a number of the commands of the set of rendering and compute commands executed; or resetting the command count value based on a programming update to the profile descriptor data structure.

Aspect 10 is the method of aspect 8, further comprising: outputting an indication of the command count value.

Aspect 11 is the method of aspect 8, wherein the shader resource includes surface data associated with a surface for image data; wherein the shader resource is stored, in association with execution of one or more commands of the set of rendering and compute commands, at a local memory or at a system memory based on the command count value.

Aspect 12 is the method of aspect 8, wherein the command reference counter is one of a set of command reference counters and the descriptor reference counter is one of a set of descriptor reference counters, wherein each command reference counter in the set of command reference counters respectively corresponds to each descriptor reference counter.

Aspect 13 is the method of any of aspects 1 to 12, wherein a rendering command for the shader resource is associated with a graphic rendering draw call for image data at a surface level.

Aspect 14 is the method of any of aspects 1 to 13, wherein a compute command for the shader resource is associated with a compute shader dispatch for image data at a surface level.

Aspect 15 is the method of any of aspects 1 to 14, wherein outputting the descriptor count value includes at least one of: storing the descriptor count value in the memory; or providing the descriptor count value to a graphics driver.

Aspect 16 is an apparatus for graphics processing comprising a processor coupled to a memory and, based on information stored in the memory, the processor is configured to implement a method as in any of aspects 1-15.

Aspect 17 may be combined with aspect 16 and comprises that the apparatus is a wireless communication device.

Aspect 18 is an apparatus for graphics processing comprising means for implementing a method as in any of aspects 1-15.

Aspect 19 is a computer-readable medium (e.g., a non-transitory computer readable-medium) storing computer executable code, the computer executable code, when executed by a processor, causes the processor to implement a method as in any of aspects 1-15.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
receive an access indication indicative of an access, to a profile descriptor data structure, for a descriptor associated with a set of rendering and compute commands for a shader resource;
update, based on the access indication, a descriptor count value of a descriptor reference counter that corresponds to the descriptor; and
output an indication of the descriptor count value.

2. The apparatus of claim 1, wherein the profile descriptor data structure is a high level sequencer (HLSQ) remapping table that includes at least one of a descriptor lookup key or an address associated with the descriptor.

3. The apparatus of claim 1, wherein to update the descriptor count value, the processor is configured to:
increment the descriptor count value based on the access indication; or
reset the descriptor count value based on a programming update to the profile descriptor data structure.

4. The apparatus of claim 1, wherein the descriptor associated with the set of rendering and compute commands for the shader resource is indicative of at least one of a buffer, a buffer view, an image view, a sampler, or a combined image sampler.

5. The apparatus of claim 1, wherein the shader resource is stored at a system memory based on the descriptor count value failing to meet a usage threshold.

6. The apparatus of claim 1 wherein the updated descriptor count value corresponds to an increase, wherein the shader resource is stored in a local memory based on the increase and a usage threshold being met.

7. The apparatus of claim 1, wherein the descriptor reference counter is one of a set of descriptor reference counters, wherein each descriptor reference counter in the set of descriptor reference counters respectively corresponds to each shader resource of a set of shader resources.

8. The apparatus of claim 1, wherein the processor is further configured to:
update a command count value of a command reference counter that corresponds to the descriptor reference counter for commands of the set of rendering and compute commands executed in association with the access indication for the descriptor.

9. The apparatus of claim 8, wherein to update the command count value, the processor is configured to:
increment the command count value based on a number of the commands of the set of rendering and compute commands executed; or
reset the command count value based on a programming update to the profile descriptor data structure.

10. The apparatus of claim 8, wherein the processor is further configured to:
output an indication of the command count value.

11. The apparatus of claim 8, wherein the shader resource includes surface data associated with a surface for image data;
wherein the shader resource is stored, in association with execution of one or more commands of the set of rendering and compute commands, at a local memory or at a system memory based on the command count value.

12. The apparatus of claim 8, wherein the command reference counter is one of a set of command reference counters and the descriptor reference counter is one of a set of descriptor reference counters, wherein each command reference counter in the set of command reference counters respectively corresponds to each descriptor reference counter.

13. The apparatus of claim 1, wherein a rendering command for the shader resource is associated with a graphic rendering draw call for image data at a surface level.

14. The apparatus of claim 1, wherein a compute command for the shader resource is associated with a compute shader dispatch for image data at a surface level.

15. The apparatus of claim 1, wherein to output the descriptor count value, the processor is configured to perform at least one of:
store the descriptor count value in the memory; or
provide the descriptor count value to a graphics driver.

16. The apparatus of claim 1, wherein the apparatus comprises a wireless communication device.

17. A method of graphics processing, comprising:
receiving an access indication indicative of an access, to a profile descriptor data structure, for a descriptor associated with a set of rendering and compute commands for a shader resource;
updating, based on the access indication, a descriptor count value of a descriptor reference counter that corresponds to the descriptor; and
outputting an indication of the descriptor count value.

18. The method of claim 17, wherein the profile descriptor data structure is a high level sequencer (HLSQ) remapping table that includes at least one of a descriptor lookup key or an address associated with the descriptor;
wherein updating the descriptor count value includes:
incrementing the descriptor count value based on the access indication,
or resetting the descriptor count value based on a programming update to the profile descriptor data structure; or
wherein the descriptor associated with the set of rendering and compute commands for the shader resource is indicative of at least one of a buffer, a buffer view, an image view, a sampler, or a combined image sampler.

19. The method of claim 17, wherein the shader resource is stored at a system memory based on the descriptor count value failing to meet a usage threshold; or
wherein the updated descriptor count value corresponds to an increase, wherein the shader resource is stored in a local memory based on the increase and a usage threshold being met

20. A computer-readable medium storing computer executable code at a device, the code when executed by a processor causes the processor to:
receive an access indication indicative of an access, to a profile descriptor data structure, for a descriptor associated with a set of rendering and compute commands for a shader resource;
update, based on the access indication, a descriptor count value of a descriptor reference counter that corresponds to the descriptor; and
output an indication of the descriptor count value.
